(19) United States
(12) Patent Application Publication
(10) Pub. No.: US 2023/0087336 A1
(43) Pub. Date: Mar. 23, 2023

(54) MACHINE-LEARNING PROCESSING OF AGGREGATE DATA INCLUDING RECORD-SIZE DATA TO PREDICT FAILURE PROBABILITY

(71) Applicant: Institute for Systems Biology, Seattle, WA (US)

(72) Inventors: Jennifer Hadlock, Seattle, WA (US); Jewel Lee, Seattle, WA (US)

(73) Assignee: Institute for Systems Biology, Seattle, WA (US)

(21) Appl. No.: 17/933,991

(22) Filed: Sep. 21, 2022

Related U.S. Application Data
(60) Provisional application No. 63/247,044, filed on Sep. 22, 2021.

(51) Int. Cl. G06F 11/07; G06N 7/00

(52) U.S. Cl. CPC G06F 11/079; G06F 11/0721; G06N 7/005

(57) ABSTRACT

Machine-learning processing of aggregate data including record-size data to predict failure probability is described herein. In an example, a system identifies electronic data that is longitudinal and includes a set of electronic records pertaining to a given subject or to a given object. The system generates a record-size metric that characterizes a size of the electronic data and determines a physical attribute of the given subject or the given object. The system generates a physical-attribute metric based on the physical attribute, generates an input data set that includes the record-size metric and the physical-attribute metric, and generates a failure probability across a given time period and for the given subject or the given object by processing the input data set using a trained machine-learning model. The system determines that an alert condition is satisfied based on the failure probability and outputs an alert representing the failure probability.

### CROSS-REFERENCE TO RELATED APPLICATIONS

This application claims the benefit of and the priority to U.S. Provisional Application No. 63/247,044, filed on Sep. 22, 2021, which is hereby incorporated by reference for all purposes.

### FIELD

Embodiments relate to generating a predicted failure probability by using a machine-learning model to process aggregate data based on electronic record data and potential sensor data. The aggregate data may include one or more statistics that represent a size of some or all electronic record data that corresponds to a given subject or object.

### BACKGROUND

Fluid operations of various types of systems support seamless communication, infrastructure, survival, and data processing. However, if a given system fails, such results may not be possible.

Various types of system fails are actionable, meaning that—if that a fail can be predicted and one or more particular actions can be performed sufficiently early—the failure may be avoided. These circumstances require that a predicted failure be identified sufficiently far in advance to perform the particular action(s). This can be difficult when there are no outward indicators of a poor-performing system.

Further, performing the particular action(s) may have various types of cost. Not only may the particular action(s) result in resource costs, but they may potentially risk harming the object or subject on which the particular action(s) are performed. Therefore, false positives of failure prediction may be consequential.

Further yet, there can be a very large number of objects and/or subjects prone to failure, and failure risks may vary in time.

Therefore, it would be advantageous to monitor and process pertinent indicators to predict potential failures so as to issue alerts which may facilitate initiate actions that may prevent such failures.

### SUMMARY

Embodiments of the present disclosure relate to using a machine-learning model to process aggregate data based on electronic record data and potential sensor data to generate a failure probability. In some embodiments, a computer-implemented method is provided that involves identifying electronic data that is longitudinal and includes a set of electronic records pertaining to a given subject or to a given object. Each electronic record of the set of electronic records includes a timestamp and identifies an observation made by, process performed by, or diagnosis made by a verified entity across a predefined time period of at least six months. The computer-implemented method also involves generating a record-size metric that characterizes a size of the electronic data and determining a physical attribute of the given subject or the given object. The physical attribute corresponds to a size, a dimension, weight or age. The computer-implemented method involves generating a physical-attribute metric based on the physical attribute, generating an input data set that includes the record-size metric and the physical-attribute metric, generating a failure probability across a given time period of at least one week and for the given subject or the given object by processing the input data set using a trained machine-learning model. The computer-implemented method also involves determining that an alert condition is satisfied based on the failure probability and in response to determining that the alert condition is satisfied, outputting an alert representing the failure probability.

In some embodiments, the record-size metric identifies a total quantity of electronic records in the set of electronic records.

In some embodiments, the record-size metric identifies a quantity of unique electronic records in the set of electronic records.

In some embodiments, the physical attribute identifies an age.

In some embodiments, the computer-implemented method further involves collecting one or more vital-sign measurements using a sensor that is attached to or worn by the given subject or the given object and generating a vital-sign metric based on the vital-sign measurements, wherein the input data set includes the vital-sign metric.

In some embodiments, the computer-implemented method further involves collecting one or more movement measurements using a sensor that is attached to or worn by the given subject or the given object and generating a movement metric based on the movement measurements, wherein the input data set includes the movement metric.

In some embodiments, the alert is output on a device that includes the sensor.

In some embodiments, the computer-implemented method further involves collecting one or more vital-sign measurements using a sensor that is attached to or worn by the given subject or the given object; determining that an additional alert condition is satisfied based on the vital-sign measurements; and in response to determining that the additional alert condition is satisfied, outputting another alert.

In some embodiments, a system is provided that includes one or more data processors and a non-transitory computer readable storage medium containing instructions which, when executed on the one or more data processors, cause the one or more data processors to perform a set of actions including identifying electronic data that is longitudinal and includes a set of electronic records pertaining to a given subject or to a given object. Each electronic record of the set of electronic records includes a timestamp and identifies an observation made by, process performed by, or diagnosis made by a verified entity across a predefined time period of at least six months. The set of actions also involve generating a record-size metric that characterizes a size of the electronic data and determining a physical attribute of the given subject or the given object. The physical attribute corresponds to a size, a dimension, weight or age. The set of actions involve generating a physical-attribute metric based on the physical attribute, generating an input data set that includes the record-size metric and the physical-attribute metric, generating a failure probability across a given time period of at least one week and for the given subject or the given object by processing the input data set using a trained machine-learning model. The set of actions also involve determining that an alert condition is satisfied based on the failure probability and in response to determining that the alert condition is satisfied, outputting an alert representing the failure probability.

In some embodiments, a computer-program product is provided that is tangibly embodied in a non-transitory machine-readable storage medium and that includes instructions configured to cause one or more data processors to perform a set of actions including identifying electronic data that is longitudinal and includes a set of electronic records pertaining to a given subject or to a given object. Each electronic record of the set of electronic records includes a timestamp and identifies an observation made by, process performed by, or diagnosis made by a verified entity across a predefined time period of at least six months. The set of actions also involve generating a record-size metric that characterizes a size of the electronic data and determining a physical attribute of the given subject or the given object. The physical attribute corresponds to a size, a dimension, weight or age. The set of actions involve generating a physical-attribute metric based on the physical attribute, generating an input data set that includes the record-size metric and the physical-attribute metric, generating a failure probability across a given time period of at least one week and for the given subject or the given object by processing the input data set using a trained machine-learning model. The set of actions also involve determining that an alert condition is satisfied based on the failure probability and in response to determining that the alert condition is satisfied, outputting an alert representing the failure probability.

### BRIEF DESCRIPTION OF THE DRAWINGS

The present disclosure is described in conjunction with the appended figures:

FIG. 1 shows an exemplary computing system for training and using a machine-learning model to facilitate identification of a failure probability according to some aspects of the present disclosure;

FIG. 2 illustrates an exemplary process of using machine-learning processing of aggregate data including record-size data to predict failure probability according to some aspects of the present disclosure;

FIG. 3 illustrates exemplary training, validation and test splitting for risk modeling;

FIG. 4A shows SHAP algorithm results for long-term sepsis risk using a first machine-learning model;

FIG. 4B shows SHAP algorithm results for long-term sepsis risk using a first machine-learning model, and in particular, the ranking of feature importance indicated by SHAP;

FIG. 5A shows SHAP algorithm results for long-term sepsis risk using a second machine-learning model;

FIG. 5B shows SHAP algorithm results for long-term sepsis risk using a second machine-learning model, and in particular, the ranking of feature importance indicated by SHAP;

FIG. 6A shows SHAP algorithm results for long-term sepsis risk using a third machine-learning model;

FIG. 6B shows SHAP algorithm results for long-term sepsis risk using a third-machine learning model, and in particular, the ranking of feature importance indicated by SHAP;

FIG. 7A shows SHAP algorithm results for long-term sepsis risk using a fourth machine-learning model;

FIG. 7B shows the SHAP algorithm results for long-term sepsis risk using a fourth machine-learning model, and in particular, the ranking of feature importance indicated by SHAP;

FIG. 8A shows L1-LR algorithm results for long-term sepsis risk using a fourth machine-learning model; and

FIG. 8B shows permutation testing results for long-term sepsis risk using a fourth machine-learning model.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Typically, system failures are addressed after they occur. For example, a cause of a failure may be identified after the failure occurs and/or an approach to attempt to restore the system may be instituted after the system failure occurs. However, this type of approach may be inefficient (e.g., as it may require additional resources to detect the cause and/or institute the restorative actions) and/or ineffective (e.g., as restorative actions may be less effective when applied later in time).

Some embodiments relate to monitoring multiple data points (e.g., in real-time) and to generating a predicted failure probability by processing the data points using a trained machine-learning model. The data points may include dynamic data points that may change in time (e.g., in a deterministic or non-deterministic manner).

Monitoring a data point may include retrieving and/or processing one or more electronic data records. For example, a query may be sent to one or more data stores, where the query includes an identifier of a particular object or a particular subject. The query may potentially further include one or more thresholds that defines an open or closed date range and/or one or more constraints that indicate a type of record being requested.

The electronic data records may then be processed to identify one or more particular types of information that is present in each electronic data record and/or to categorize each type of electronic data record. The processing may include (for example) applying a schema, extracting key-value pairs, implementing a natural language processing technique, etc.

A data point that is monitored may (for example) correspond to a particular field in a schema, a particular key-value pair, a particular term, etc. However, because various electronic data records may differ with regard to schema, key sets, terms, etc., a mapping or extraction technique may be applied to detect whether any given electronic data record contains data that corresponds to a data point of interest.

Some data points are observational and correspond to a data type that may vary in a complex or unpredictable manner across time and/or across subjects/objects. For example, an observational data point of a computing system may include a processing load, and an observational data point of a subject may include a weight. An observational data point may be either objective (e.g., corresponding to a test result) or subjective (e.g., corresponding to an assessment conducted by a person).

Some data points are determinable, meaning that—given initial information—they change in a predictable manner. For example, a determinable data point may include an age of a system or subject.

Some data points are measurable, meaning that the data point corresponds to a detected result. A measurable data point may be determined based on (for example) data obtained from a sensor. For example, a measurable data point may identify a specific location or speed of an object or subject based on data obtained from a GPS sensor or accelerometer.

For a given subject or object, an attribute corresponding to a given type of data points can be generated. The attribute may be (for example) a most-recent value, a mean, a median, a mode, a standard deviation, a slope, etc. with respect to underlying data points. For example, with respect to a location, an attribute may be a median location over a time period. As another example, with respect to age, an attribute may be an estimated current age.

In addition to or instead of collecting individual data points from electronic data records corresponding to a query, one or more higher-level metrics may be identified. A higher-level metric may correspond to and/or characterize a specific type or multiple types of electronic data records. In some instances, determining a higher-level metric may include identifying, from among a set of electronic records corresponding to a particular object or particular subject, a subset of electronic records and identifying a quantity of electronic records in the subset. For example, the subset may be defined to be the set of electronic data records but having duplicate records removed (e.g., where a duplicate record is defined as corresponding to a same combination between two or more of a date, observation, process, and diagnosis). Thus, determining a subset may include using data extracted from records using (for example) a schema, key-value pairs, a natural language processing technique, etc. As another example, the subset may be defined to selectively include electronic data records in the set of electronic data records that apply to a particular type of potential or actual type of failure (e.g., records that pertain to communications received by a given device from unrecognized IP addresses or records that pertain to treatment viclisits (hospitalizations) of a given subject). The higher-level metric may include a normalized or raw count of the electronic data records in the subset.

A data point or higher-level metric may be generated by a sensor that is in an object or in a device attached to or worn by a subject. For example, data points may identify a specific location or speed of the object or subject based on data obtained from a GPS sensor or an accelerometer. A higher-level metric from the sensor data may be a subset of the sensor data selectively including data in the sensor data that applies to a particular value (e.g., specific locations or speeds less than or greater than a given threshold).

Machine-learning techniques may be used to predict a failure probability for a subject or an object. The machine-learning model may be (for example) a gradient boosting model, a support vector machine model, a logistic regression model, or any other suitable machine-learning model for predicting the failure probability. An input data set for a particular subject or particular object can be defined to include one or more data points and/or one or more higher-level metrics based on the electronic data of the particular subject or object. Each of one, more, or all variables in the input data set may be defined to correspond to a feature that is determined to be useful for the machine-learning model in predicting the failure probability. Due to the large number of data points included in the electronic data for a subject or object, it may be advantageous to perform feature selection to reduce a training time and complexity of the machine-learning model. Feature selection can determine which features should be included in the input data set and which features may be irrelevant or redundant, and therefore can be excluded from the input data set. Feature selection may be performed by a supervised, semi-supervised, or unsupervised feature selection model. For supervised feature selection, labels indicating an outcome (e.g., failure outcome or non-failure outcome) for the subject or object may be used in association with the electronic data. Data points related to the selected features can be extracted from the electronic data and included in the input data set.

The trained machine-learning model outputs a prediction of a failure probability based on the input data set. The failure probability may be a quantitative or qualitative likelihood of the subject or object experiencing a failure (e.g., data communication failure for an object or a medical outcome for a subject) in a given time period (e.g., one week, six months, two years, etc.). For example, the failure probability may be a decimal (e.g., between 0 and 1) or percentage of the likelihood that the object or subject will experience the failure. Or, the failure probability may be a textual indication (e.g., “high”, “medium”, “low”, etc.) of the likelihood that the object or subject will experience the failure. A qualitative output can be derived based on comparing a quantitative output of the trained machine-learning model to one or more thresholds (e.g., below 0.25 for “low” or above 0.75 for “high”).

An alert may be generated based on the output of the trained machine-learning model satisfying an alert criterion (e.g., the output being above a given threshold). The alert may be communicated to a remote system or be presented on a device associated with the subject or object. The remote system may (for example) be a device associated with a user of the object or a device associated with a physician or other personnel associated with the subject. The alert can identify the failure probability so that remedial action may be taken before the failure occurs. In some instances, the alert may include a suggested remedial action, such as seeking treatment.

Including higher-level metrics of electronic data in the training and analysis of the machine-learning model may provide advantages over conventional systems that include machine-learning models using only data points of the electronic data. For instance, a particular higher-level metric (e.g., an amount of electronic data associated with a subject or object) may be a significant indicator of whether a failure is likely to occur for the subject or the object. So, including the higher-level metric in the training of the machine-learning model and as an input to the trained machine-learning model may result in the trained machine-learning model generating more accurate failure probabilities. In addition, there may be advantages associated with using a device associated with the object or subject to monitor electronic data. For example, the device may facilitate real-time analysis and failure probability prediction of the electronic data. That is, as the electronic data is collected, it can be processed by a trained machine-learning model that outputs the failure probability. If the failure probability is high (e.g., above a threshold), the object, subject, or other verified entity can then be notified via the device so that remedial action can be taken before the failure occurs. In an example in which the object is a computing system, performing a remedial action prior to the failure may conserve resources involved in fixing the computing system after the failure occurs.

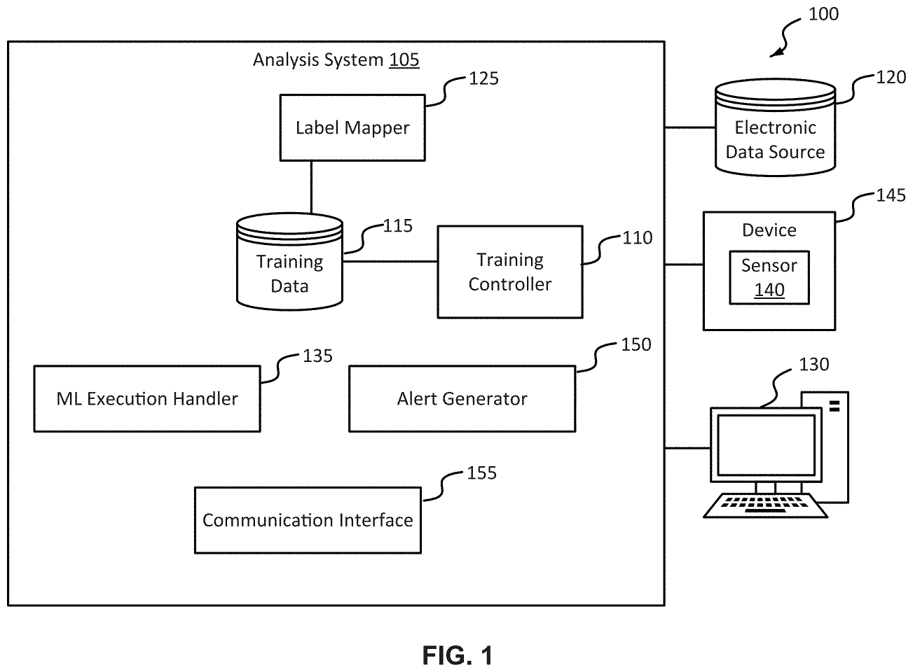

FIG. 1 shows an exemplary computing system 100 for training and using a machine-learning model to facilitate identification of a failure probability. The computing system 100 can include an analysis system 105 to train and execute the machine-learning model. Examples of the machine-learning model include a gradient boosting model, a support vector machine model, and/or logistic regression model. The machine-learning model may be trained and/or used to (for example) predict a failure probability in a given time period based on electronic record data of a subject or object. The analysis system 105 may further train and/or use one or more other machine-learning models to perform a same or different type of prediction based on a same or different set of features. The other machine-learning model(s) may include (for example) a gradient boosting model, a support vector machine model, and/or logistic regression model.

In some instances, a training controller 110 can execute code to train the machine-learning model and/or the other machine-learning model(s) using training data 115 of one or more training data sets. Each training data set of the training data 115 can include a set of training electronic data for subjects and objects. The electronic data can include sets of electronic records identifying observations made by, processes performed by, or diagnoses made by a verified entity for the subjects or the objects. The training data 115 can also include data identifying physical attributes (e.g., size, weight, color, age, etc.) of the subject or object and timestamps associated with the identified physical attributes. The training data 115 can be longitudinal electronic data for the subjects and objects across a predefined time period of at least six months (e.g., six months, one year, two years, three years, etc.). A higher-level metric of at least a record-size metric may be generated for each subject or object in the training data 115, and the higher-level metric can be included in the training data 115. The record-size metric can characterize a size of the electronic data for the subject or object. Each electronic record in a first subset of the set of training electronic data may be associated with a failure outcome for the subject or object, and each electronic record in a second subset of the set of training electronic data may be associated with a non-failure outcome for the subject or object (e.g., the subject or object did not experience the failure). The training data 115 may have been collected (for example) from an electronic data source 120, which can be a data store that stores electronic records for subjects and/or objects.

The computing system 100 can include a label mapper 125 that maps electronic records of the training data 115 associated with a failure outcome to a “failure” label and that maps electronic records of the training data 115 that are not associated with a failure outcome to a “non-failure” label. Mapping data may be stored in a mapping data store (not shown). The mapping data may identify each electronic record that is mapped to either of the failure label or non-failure label. In some instances, labels associated with the training data 115 may have been received or may be derived from data received from one or more provider systems 130, each of which may be associated with (for example) a user, nurse, treatment facility, etc. associated with a particular object or particular subject.

Training controller 110 can use the mappings of the training data 115 to train a machine-learning model. More specifically, training controller 110 can access an architecture of a model (e.g., gradient boost model), define (fixed) hyperparameters for the model (which are parameters that influence the learning rate, size, and complexity of the model, etc.), and train the model such that a set of parameters are learned. More specifically, the set of parameters may be learned by identifying parameter values that are associated with a low or lowest loss, cost or error generated by comparing predicted outputs (obtained using given parameter values) with actual outputs.

A machine learning (ML) execution handler 135 can use the architecture and learned parameters to process non-training data and generate a result. For example, ML execution handler 135 may access an input data set that includes electronic data and/or higher-level metrics based on the electronic data, for a given subject or object. The electronic data generated based on an observation made by, a diagnosis made by, or a process performed by a verified entity. In addition, the electronic data is longitudinal data and each electronic record in the set of electronic records for the given subject or object is associated with a timestamp. The analysis system 105 can access the electronic data source 120 by sending a query including an identifier of a particular object or a particular subject and, optionally, a date range or other constraints indicating the electronic data being requested to the electronic data source 120. The date range may be a time period of at least six months. The electronic records in the electronic data source 120 may then be processed (e.g., by applying a schema, extracting key-value pairs, implementing a natural language processing technique, etc.) to identify one or more particular types of information that is present in each electronic data record and/or to categorize each type of electronic data record. A mapping or extraction technique may be applied to detect whether any given electronic data record contains data that corresponds to a data point of interest.

Data points in the electronic data source 120 may be observational, determinable, and/or measureable. Observational data points are subjective data points or objective data points that may vary in a complex or unpredictable manner across time and/or across subjects/objects. For example, an observational data point of a computing system may include a processing load, and an observational data point of a subject may include a weight. Determinable data points are data points that change in a predictable manner, such as an age of a system or subject. Measureable data points are data points that correspond to a detected result. A measurable data point may be determined based on (for example) data obtained from a sensor 140 (e.g., accelerometer), which may be in an object or in a device 145 that is attached to or worn by a subject.

In some instances, in addition to or instead of collecting individual data points from the electronic data source 120 corresponding to the query, one or more higher-level metrics may be identified. A higher-level metric may correspond to and/or characterize a specific type or multiple types of electronic data records. The higher-level metric may be a record-size metric that characterizes a size of the electronic data for the subject or the object. For example, the record-size metric may identify a total quantity of electronic records in the set of electronic records for the subject or object. In some instances, determining a higher-level metric may include identifying a subset of the electronic record data from among the set of electronic records corresponding to a particular object or particular subject. In such instances, the record-size metric may identify a quantity of unique electronic records in the set of electronic records for the subject or object. For example, the subset may be defined to be the set of electronic data records but having duplicate records removed (e.g., where a duplicate record is defined as corresponding to a same combination between two or more of a date, observation, process, and diagnosis). Thus, determining a subset may include using data extracted from the electronic record data using (for example) a schema, key-value pairs, a natural language processing technique, etc. As another example, the subset may be defined to selectively include electronic data records in the set of electronic data records that apply to a particular type of potential or actual type of failure (e.g., records that pertain to communications received by a given device from unrecognized IP addresses or records that pertain to treatment visits of a given subject). The higher-level metric may include a normalized or raw count of the electronic data records in the subset.

In some instances, the analysis system 105 may determine a physical attribute of the given subject or the given object. The physical attribute may be determined from the electronic record data for the subject or object received from the electronic data source 120, or from a remote system, such as from a provider system 130 associated with a user of the object or physician of the subject. The physical attribute can correspond to a size, dimension, weight, or age of the subject or object. In some embodiments, a higher-level metric may also be generated based on the physical attribute. The higher-level metric can be a physical-attribute metric, such as an expected age of the subject at a given time, a median age of the subject, a mean age of the subject, etc.

Higher-level metrics based on sensor data collected by the sensor 140 may also be generated. For example, one or more vital-sign measurements (e.g., blood pressure, pulse, temperature, etc.) may be collected by the sensor 140. The analysis system 105 can generate a vital-sign metric based on the vital-sign measurements. For instance, the vital-sign metric may be a most-recent value, a mean, a median, a mode, a standard deviation, a slope, etc. of the vital-sign measurements. Additionally or alternatively, one or more movement measurements may be collected by the sensor 140, and the analysis system 105 can generate a movement metric based on the movement measurements. The movement metric may be a most-recent value, a mean, a median, a mode, a standard deviation, a slope, etc. of the movement measurements.

The input data set accessed by the ML execution handler 135 can include the record-size metric, the physical-attribute metric, the vital-sign metric, and/or the movement metric. The input data set can be fed into a machine-learning model having an architecture used during training and configured with learned parameters. The ML execution handler 135 may include multiple machine-learning models, each associated with a different set of features to be included in the input data set based on the training of each of the machine-learning models. For example, the input data set for a first trained machine-learning model may include electronic data pertaining to physical attributes of the subject or object and the physical-attribute metric for the subject or object. The input data set for a second trained machine-learning model may include the physical attributes and the physical-metric along with vital sign measurements and/or a vital-sign metric for the given subject or object. The input data set for a third trained machine-learning model may include electronic data pertaining to physical attributes, the physical-attribute metric, the vital sign measurements, the vital sign metric, along with a record-size metric for the subject or object. The machine-learning model can output a prediction of a failure probability across a given period of time of at least one week (e.g., one week, one month, one year, two years, etc.) for the given subject or the given object. The output may be a percentage likelihood of the subject or object experiencing the failure in the given time period. The ML execution handler 135 can output the prediction for subsequent analysis.

In some instances, subsequent processing is performed by an alert generator 150. The alert generator 150 may receive the output of the failure probability for the given object or the given subject and determine whether an alert condition is satisfied. For example, an alert condition may be the failure probability being above a threshold (e.g., 0.6). If the alert condition is satisfied (e.g., the failure probability is 0.8), the alert generator 150 can determine that an alert representing the failure probability is to be output. The alert generator 150 may determine a remedial action that can be performed based on the failure probability. For example, the remedial action may be decreasing movement or seeking treatment. Different failure probabilities may be mapped to different remedial actions, so the alert generator 150 can determine the remedial action associated with the failure probability of the output of the machine-learning model.

The alert generator 150 may additionally receive the one or more vital-sign measurements collected by the sensor 140 and determine whether another alert condition is satisfied. For example, the alert condition may be a particular vital sign, or vital-sign metric, being above a threshold. If the alert condition is satisfied, the alert generator 150 can determine that an alert representing the vital-sign measurements is to be output.

A communication interface 155 can collect results and communicate the result(s) (or a processed version thereof) to the device 145 (e.g., associated with the subject), the provider system 130 (e.g., associated with a user of the object or a care provider of the subject), or another system. For example, communication interface 155 may generate and output an alert representing the failure probability (and optionally the remedial action) based on the alert generator 150 determining that the alert condition is satisfied. The alert may then be presented and/or transmitted, which may facilitate a display of the failure probability, for example on a display of a computing device. The electronic record data may be processed by the analysis system 105 in real-time, such that the alert can be output before a failure occurs. The user, subject, or care provider can then perform the remedial action based on the alert.

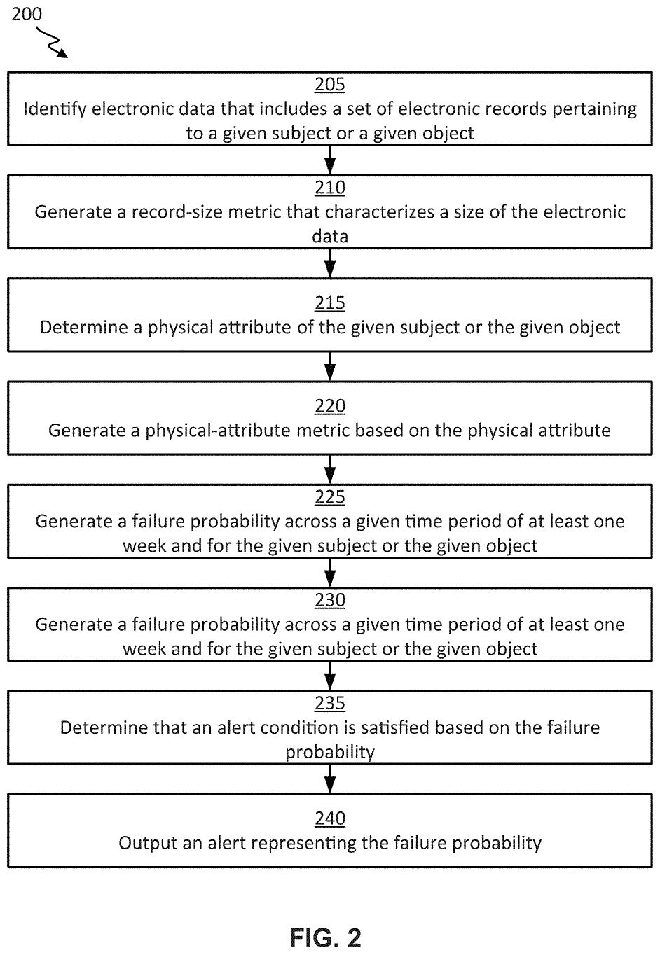

FIG. 2 illustrates an exemplary process 200 of using machine-learning processing of aggregate data including record-size data to predict failure probability according to some aspects of the present disclosure. At block 205, electronic data that includes a set of electronic records pertaining to a given subject or a given object is identified. The electronic data can be longitudinal data for the given subject or the given object. Each electronic record of the set of electronic records can include a timestamp and identifies an observation made by, process performed by, or diagnosis made by a verified entity. The set of electronic records may be received from a data store based on a query requesting electronic records for the given subject or the given object. The query may define a date range for the requested electronic records, and the data store can be parsed to identify electronic records with a timestamp within the date range.

At block 210, a record-size metric is generated that characterizes a size of the electronic data. In an example, the record-size metric can identify a total quantity of electronic records in the set of records. In another example, the record-size metric can identify a quantity of unique electronic records in the set of records.

At block 215, a physical attribute of the given subject or the given object is determined. The physical attribute may be a size, dimension, weight, color, age, etc. of the subject or object determined from the electronic data. Or, rather than being determined from the set of electronic records, physical attribute may be determined based on one or more additional observations made by a verified entity and communicated to an analysis system.

At block 220, a physical-attribute metric is generated based on the physical attribute. The physical-attribute metric may be an expected physical attribute of the subject or object at a given time, a most-recent value, a mean, a median, a mode, a standard deviation, a slope, etc. of the physical attribute in the set of electronic records.

At block 225, an input data set that includes the record-size metric and the physical-attribute metric is generated. The input data set may additionally include other data based on the training of a machine-learning model. For instance, the input data set may additionally include a vital-sign metric generated based on vital-sign measurements collected using a sensor that is attached to or worn by the given subject or the given object. Additionally or alternatively, the input data set may include a movement metric generated based on movement measurements collected using a sensor that is attached to or worn by the given subject or the given object.

At block 230, a failure probability across a given time period of at least one week and for the given subject or the given object is generated. The input data set can be processed using a trained machine-learning model that generates the failure probability. The failure probability may be output as a binary value, a score between zero and one, or a textual indicator. A higher failure probability can correspond to a higher likelihood of the given subject or the given object experiencing the failure in the given time period. That is, a failure probability of 75% for a subject can correspond to a higher likelihood that the subject will experience the failure in the given time period than a failure probability of 25%.

At block 235, an alert condition is determined to be satisfied based on the failure probability. The alert condition may be a failure probability threshold. So, by comparing the failure probability to the failure probability threshold, it can be determined whether the alert condition is satisfied. As an example, the failure probability threshold may be 0.65, so the alert condition may be determined to be satisfied if the failure probability is greater than 0.65 for the given subject or the given object.

At block 240, an alert representing the failure probability is output. The alert may be output on the device that includes the sensor and is attached to or worn by the given subject or the given object. The alert may additionally or alternatively be output to a device associated with the verified entity. In some instances, the alert can include an indication of a remedial action that can be performed based on the failure probability. The alert can be output in real-time to facilitate quick notification of the given subject, the given object, and/or the verified entity to decrease a likelihood of the failure occurring.

FIG. 2 shows one exemplary process for using a machine-learning model to predict a failure probability. Other examples can include more steps, fewer steps, different steps, or a different order of steps.

### Examples

The following examples are provided to illustrate certain particular features and/or embodiments. These examples should not be construed to limit the disclosure to the particular features or embodiments described.

### Data and Study Setting

A retrospective analysis used data from a record system for subjects who presented for monitoring at various sites. The analysis was conducted within a secure data platform, after date shifting had been applied to reduce the likelihood of rediscovery. Dates of record data entries were shifted using a randomly selected offset per subject of up to ±365 days. All time windows below were defined on post-shifted dates. Procedures were approved by a Board at associated with the record system (Number STUDY2019000389). Record data identifying an observation made by, process performed by, or diagnosis made by a verified entity across a time period was included for subjects who presented for monitoring at least one time between 2017 and 2019. In addition, subjects were selected that were over 18 years of age during a 3-year observation window starting in 2014, and subjects with no valid birthdate or no encounters prior to 2014 were not included in the selected subject group. A trained machine-learning model for generating a failure probability received record data from the selected subject group to determine a likelihood of sepsis in a 2-year window, starting in 2017. Subject age was calculated for the evaluation window start date. The selected subject group consisted of 2,683,049 subjects, including 1,558,851 (58.1%) women and 1,124,198 (41.9%) men, and the median age was 51.36 years. Over 64,000,000 encounters were collected from the subject group for feature extraction.

### Features and Label Extraction

Features represent information about the data used as model inputs, and the label is the outcome that the model is trained to predict. In this analysis, features were selected that were determinable from record data, including previously reported long-term indicators for sepsis and potential indicators for investigation. Binary outcome variables were used in labeling for classification (1 for sepsis and 0 for no sepsis). Sepsis was defined using the Systematized Nomenclature of Medicine hierarchical terminology system. The label was set to 1 if the parent concept for sepsis, SNOMED identifier (SCTID=91302008), or any of its descendants was found in the problem list during the observation window.

Physical-attribute features, record-size features, vital-sign features, and historical features were extracted from the observation window. Examples of the extracted features include sex, age, ethnicity, height, weight, body mass index (BMI), vital signs, history of conditions, length of treatment stay, encounters, problem list entries, history entries, treatment orders, and procedures. Conditions were considered present if the SNOMED parent concept or any of its descendant concepts were found in the record data during the observation window. The sepsis feature was included to investigate whether having a history of sepsis is an indicator for developing sepsis in the future. Ratio features with repeated observations (e.g., BMI, vital signs, and length of treatment stay) were transformed through statistical aggregation (minimum, maximum, mean, and standard deviation). All features are defined in Table 1 and categorized into four feature sets as follows: physical attributes, vital signs, history, and record-size data. In total, 49 features were entered into the supervised machine learning process.

TABLE 1
Definitions of features used for models in the study for the observation
window. SCTID = SNOMED identifier.

| Category | Definition |
|---|---|
| Physical Attributes | |
| Sex | Male (1), female (0), missing (−1) |
| Age | Age calculated at the start of the prediction window |
| Race | Native Hawaiian/Pacific Islander, American |
| | Indian/Alaska Native, Asian, Black/African |
| | American (1); White (0); other/missing (−1) |
| Ethnicity | Hispanic/Latino (1), not Hispanic/Latino |
| | (0), missing (−1) |
| Height | Last observed height |
| Weight | Last observed weight |
| Std_BMI | Standard deviation of BMI |
| Vital Sign Features | |
| BP_sys | Average and standard deviation of |
| | systolic blood pressure |
| BP_dia | Average and standard deviation of |
| | diastolic blood pressure |
| BT | Average and standard deviation of body temperature |
| HR | Average and standard deviation of heart rate |
| RR | Average and standard deviation of respiratory rate |
| History Features | |
| Sepsis | Sepsis (SCTID 91302008) |
| Pneumonia | Pneumonia (SCTID 233604007) |
| Bacterial infection | Bacterial infectious disease (SCTID 87628006) |
| Fungal infection | Mycosis (SCTID 3218000) |
| Protein-energy | Deficiency of macronutrients |
| malnutrition | (SCTID 238107002) |
| Cancer | Malignant neoplastic disease (SCTID 363346000) |
| COPD | Chronic obstructive lung disease (SCTID 13645005) |
| Diabetes | Diabetes mellitus (SCTID 73211009) |
| Chronic kidney disease | Chronic kidney disease (SCTID 709044004) |
| Hypertension | Hypertensive disorder, systemic arterial |
| | (SCTID 38341003) |
| Deep vein thrombosis | Deep venous thrombosis (SCTID 128053003) |
| Arteriosclerosis | Arteriosclerotic vascular disease (SCTID 72092001) |
| Peripheral artery | Peripheral arterial occlusive disease (SCTID |
| disease | 399957001) |
| Coronary artery disease | Coronary arteriosclerosis (SCTID 53741008) |
| Heart attack | Myocardial infarction (SCTID 22298006) |
| Atrial fibrillation | Atrial fibrillation (SCTID 49436004) |
| Stroke | Cerebrovascular accident (SCTID 230690007) |
| Heart failure | Heart failure (SCTID 84114007) |
| Record-Size Features | |
| n_encounter | Total count of encounters |
| n_treatment visits | Total count of treatment visits |
| LOS | Average, minimum, maximum, and standard |
| | deviation of length of treatment stays |
| n_problem | Total count of problem list entries |
| u_problem | Number of unique problem list entries |
| n_history_hx | Total count of history entries |
| u_history_hx | Number of unique history entries |
| n_medication | Total count of treatment orders |
| u_medication | Number of unique treatment orders |
| n_procedure | Total count of ordered procedures |
| u_procedure | Number of unique ordered procedures |

SCTID: Systematized Nomenclature of Medicine (SNOMED) identifier;
COPD: chronic obstructive pulmonary disease.

### Machine Learning

Data preprocessing and cleaning were conducted as follows. Missing data in categorical features (e.g., sex and ethnicity) were assigned to be —1. Missing data in height, weight, and vital signs were imputed using the carry-forward method if previous observations were available; otherwise, median imputation was used. Outliers in height and weight were detected by calculating the modified z-score based on median absolute deviation (MAD) in equation 1 with a threshold of 3.5. Both outliers and missing data were imputed with the median. Equation 1 is as follows:

Mᵢ=0.6745(xᵢ−\tilde{x})MAD (1)

where MAD is the median absolute deviation and \tilde{x} is the median of x.

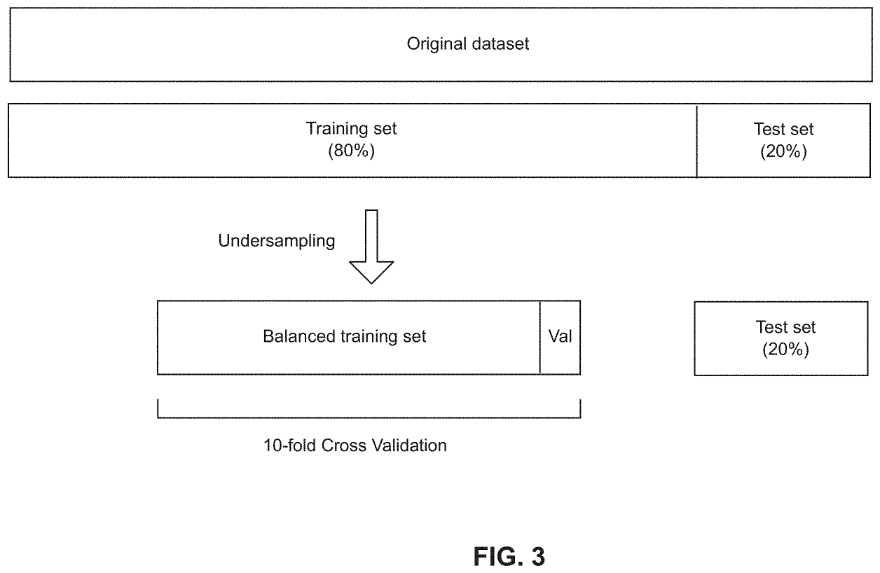

Subjects diagnosed with sepsis accounted for only about 0.8% of the selected subjects, leading to imbalanced data. To ensure the validity of the model but, at the same time, mitigate the class imbalance in the data set, 20% of the original data was reserved as a test set and the other 80% of the data was under sampled by randomly selecting the same number of subjects from the majority class (no sepsis) as the minority class (sepsis) to construct a balanced training set. The train/test split process is shown in FIG. 3. This training set was then trained with several machine learning methods, including gradient boosting (GB), support vector machine (SVM), and logistic regression (LR), and validated with 10-fold cross validation. Four machine-learning models for generating a failure probability were constructed with different combinations of feature sets. Model 1 used only the physical-attribute features. Sequentially, vital-sign features were added to model 2, history features to model 3, and record-size features to model 4.

### Model Performance Evaluation

All classification models were built using scikit-learn, an open-source Python machine learning database. Widely adopted performance measures, such as area under the receiver operating characteristic curve (AUROC), precision, sensitivity (or recall), specificity, and likelihood ratio, were used to evaluate the discrimination ability of the prediction models. Appropriate measures were selected based on the class distribution in the models. Relative feature importance was also analyzed using the following three methods: (1) Shapley Additive exPlanations (SHAP) algorithm, (2) permutation testing, and (3) model coefficients from L1-regularized logistic regression (L1-LR). SHAP, an algorithm developed from coalition game theory, calculates the average marginal contribution of a feature across all possible coalitions. Permutation testing estimates feature importance by calculating the drop in the performance after permuting the feature. A feature was considered important if shuffling its values increased the model prediction error. Shapley values and permutation feature importance computed on test data avoid the systematic bias in feature selection found with mean decrease impurity-based measures. Coefficients were retrieved from L1-LR to investigate the relevance and directionality of features. LR with L1 regularization is a sparse linear model in which coefficients for unimportant features are reduced to zero, and the sign of the coefficient suggests positive or negative association with the model outcome (sepsis).

### Cross-Validation

Table 2 shows the results of 10-fold cross-validation based on training data using GB, SVM, and LR. The results show a consistent trend of model performance, increasing as more features were added. GB marginally outperformed linear classifiers (SVM and LR) in all four models. The best AUROC of 0.8216 was achieved by model 4. The trained GB models were then used to make predictions on the 20% test data set, and they were evaluated with precision, sensitivity, specificity, positive and negative likelihood ratios, and diagnostic odds ratios because of the highly imbalanced class distribution (Table 3). The test set prevalence was 0.0079 with the subject size of 536610. The results showed that the positive likelihood ratio ranged from 2.1135 to 2.8897, and the negative likelihood ratio ranged from 0.3192 to 0.4997. Sensitivity and specificity in each model had similar results in the training set and test set for predicting the sepsis outcome.

TABLE 2
10-fold cross-validation results on the training set.

| Model and | | | | | Ten-fold |
|---|---|---|---|---|---|
| classifier | Precision | Sensitivity | Specificity | AUROC | error (%) |
| Model 1 (PA) | | | | | |
| GB | 0.6727 | 0.6725 | 0.6725 | 0.7349 | 0.29% |
| SVM | 0.6607 | 0.6606 | 0.6606 | 0.7167 | 0.27% |
| LR | 0.6569 | 0.6565 | 0.6565 | 0.7134 | 0.29% |
| Model 2 (PA + | | | | | |
| VS) | | | | | |
| GB | 0.6947 | 0.6946 | 0.6946 | 0.7595 | 0.28% |
| SVM | 0.6812 | 0.6811 | 0.6811 | 0.7425 | 0.29% |
| LR | 0.6776 | 0.6775 | 0.6775 | 0.7399 | 0.26% |
| Model 3 (PA + | | | | | |
| VS + MHX) | | | | | |
| GB | 0.7008 | 0.7006 | 0.7006 | 0.7671 | 0.20% |
| SVM | 0.6897 | 0.6868 | 0.6868 | 0.7502 | 0.17% |
| LR | 0.6893 | 0.6891 | 0.6891 | 0.7523 | 0.18% |
| Model 4 (PA + | | | | | |
| VS + MHX + | | | | | |
| RSD) | | | | | |
| GB | 0.7483 | 0.7481 | 0.7481 | 0.8216 | 0.27% |
| SVM | 0.7191 | 0.7169 | 0.7169 | 0.7910 | 0.26% |
| LR | 0.7185 | 0.7175 | 0.7175 | 0.7835 | 0.19% |

AUROC: area under the receiver operating characteristic curve;
GB: gradient boosting;
SVM: record-size data.

TABLE 3
Prediction results and 95% confidence intervals for the test set
using the trained gradient boosting model.

| | Precision, | Sensitivity, | Specificity, | LR+, | LR−, | |
|---|---|---|---|---|---|---|
| | value | value | value | value | value | |
| Model | (95% CI) | (95% CI) | (95% CI) | (95% CI) | (95% CI) | DOR |
| Model 1 | 0.0165 | 0.6552 | 0.6900 | 2.1135 | 0.4997 | 4 |
| (basic) | (0.0159- | (0.6407- | (0.6887- | (2.0670- | (0.4793- | |
| | 0.0171) | 0.6694) | 0.6912) | 2.1611) | 0.5209) | |
| Model 2 | 0.0177 | 0.6862 | 0.6980 | 2.2724 | 0.4495 | 5 |
| (basic + VS) | (0.0171- | (0.6721- | (0.6968- | (2.2256- | (0.4299- | |
| | 0.0184) | 0.7001) | 0.6993) | 2.3202) | 0.4701) | |
| Model 3 | 0.0184 | 0.6874 | 0.7084 | 2.3570 | 0.4413 | 5 |
| (basic + VS + | (0.0177- | (0.6733- | (0.7071- | (2.3086- | (0.4220- | |
| MHX) | 0.0190) | 0.7012) | 0.7096) | 2.4065) | 0.4615) | |
| Model 4 | 0.0224 | 0.7653 | 0.7352 | 2.8897 | 0.3192 | 9 |
| (basic + VS + | (0.0217- | (0.7523- | (0.7340- | (2.8401- | (0.3023- | |
| MHX + RSD) | 0.0231) | 0.7779) | 0.7363) | 2.9401) | 0.3371) | |

LR+: positive likelihood ratio;
LR−: negative likelihood ratio;
DOR: diagnostic odds ratio;
PA: physical attributes;
VS: vital signs;
MHX: history;
and RSD: record-size data.

### SHAP and Permutation Testing

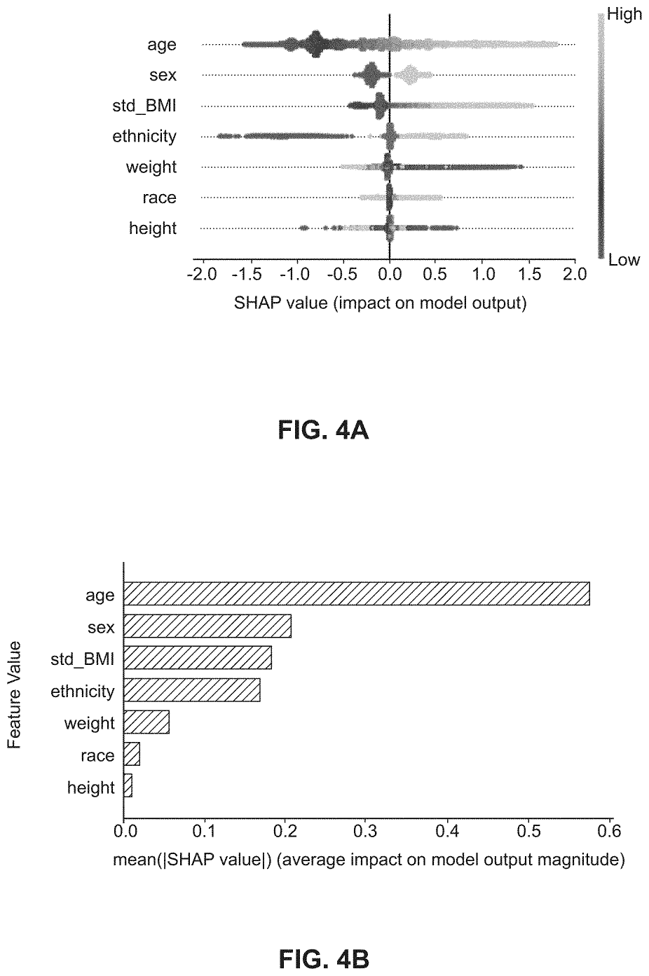

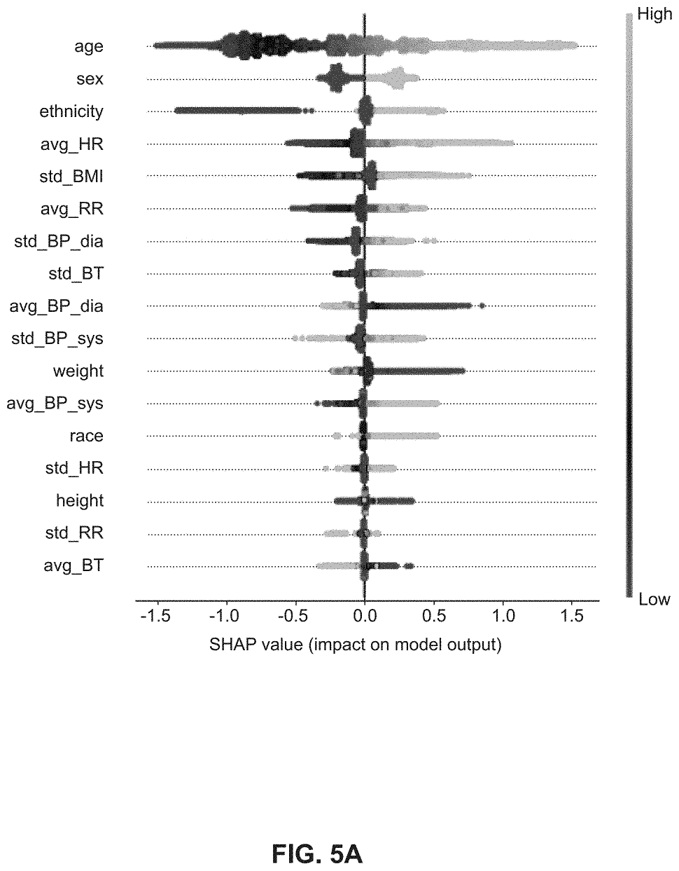

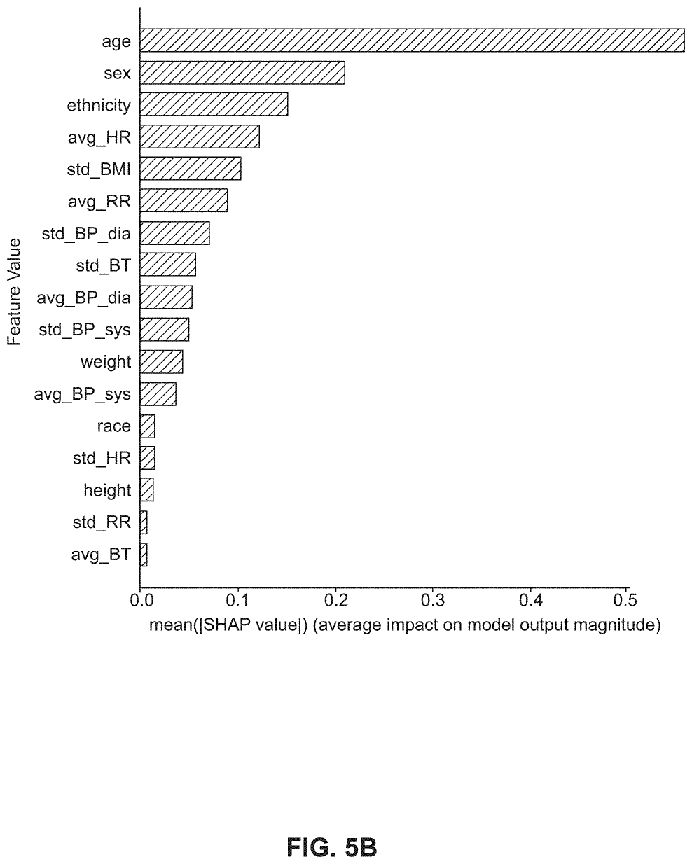

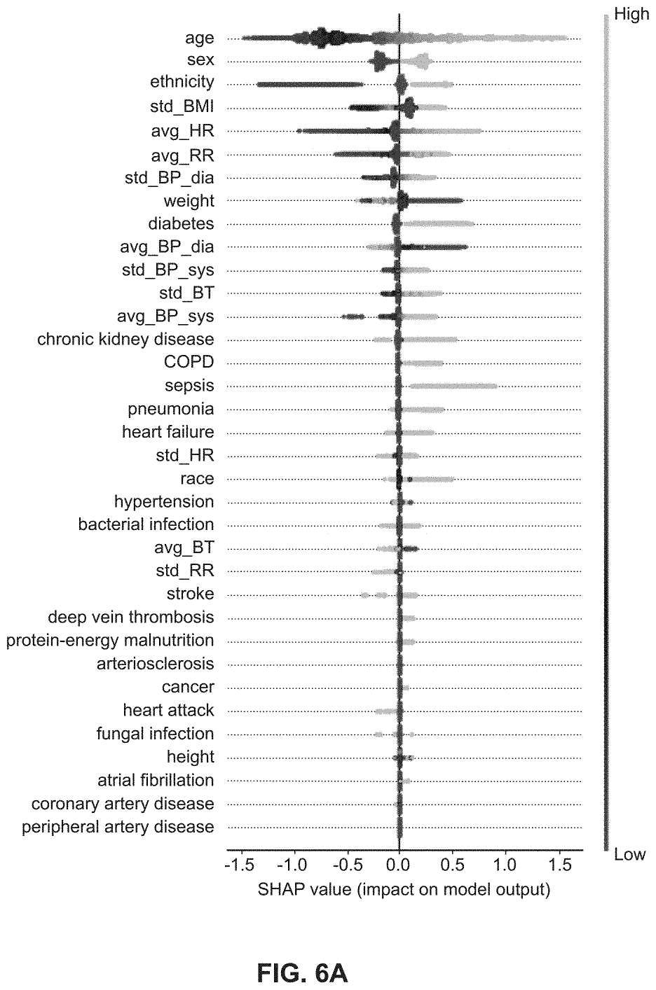

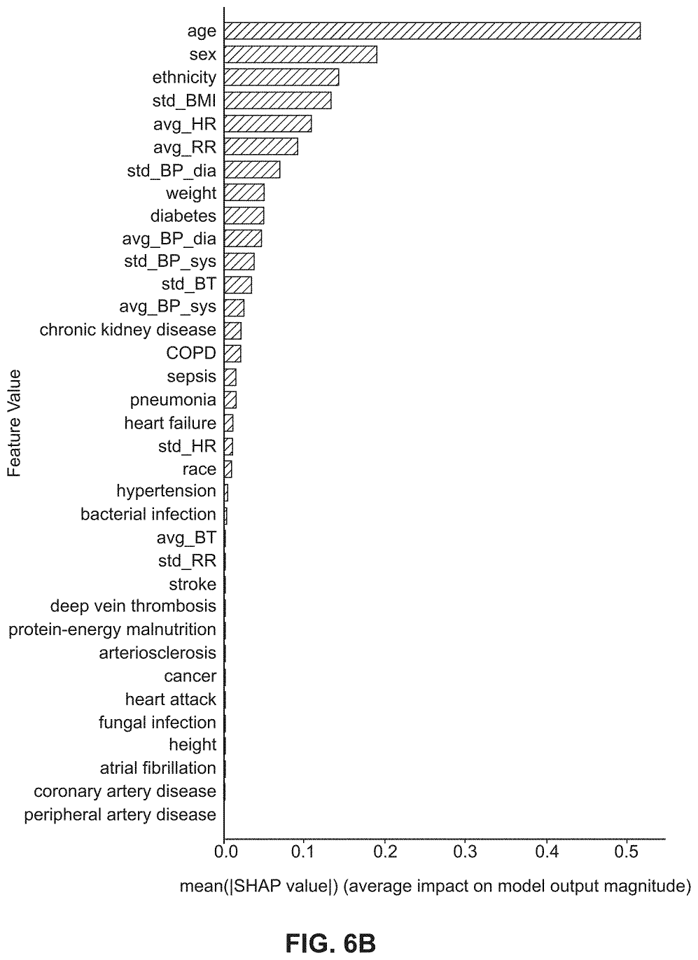

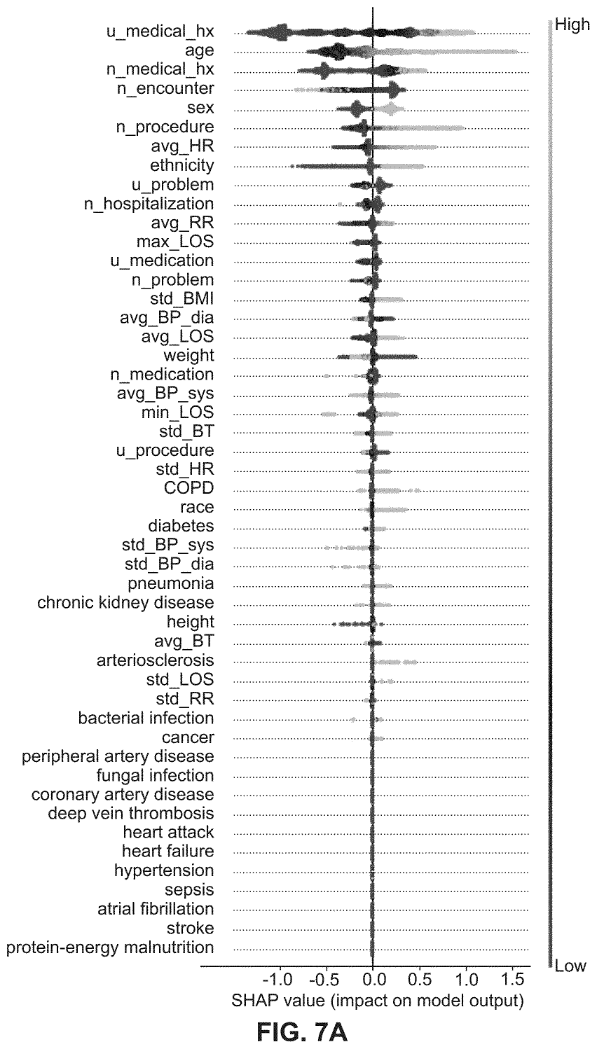

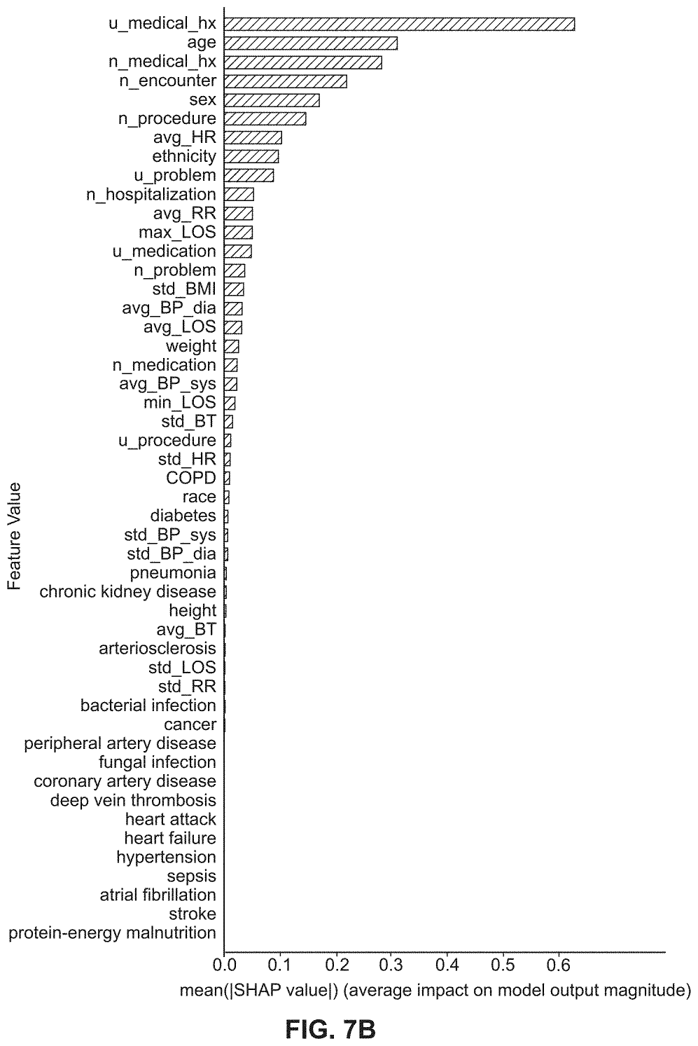

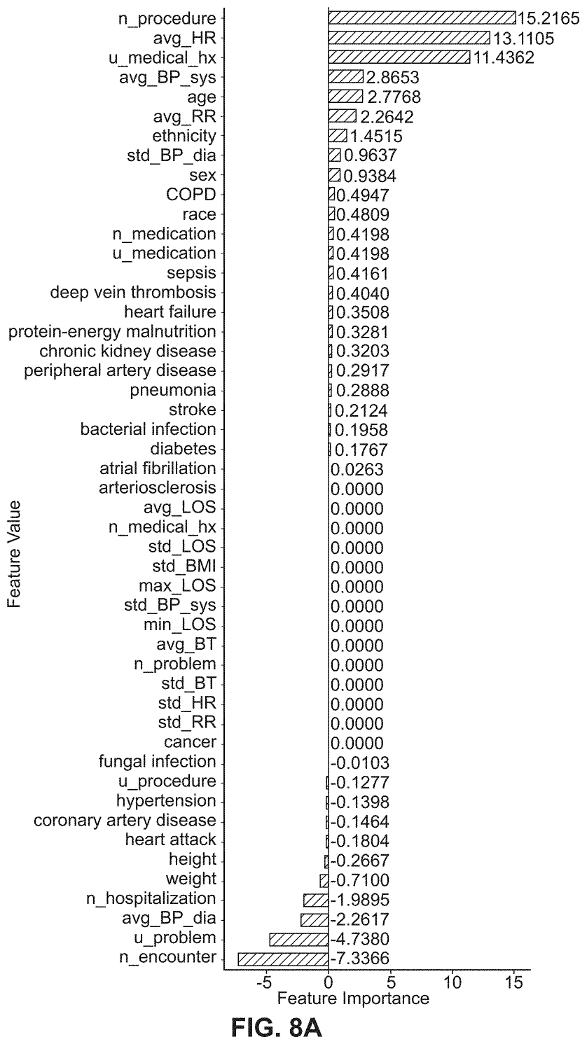

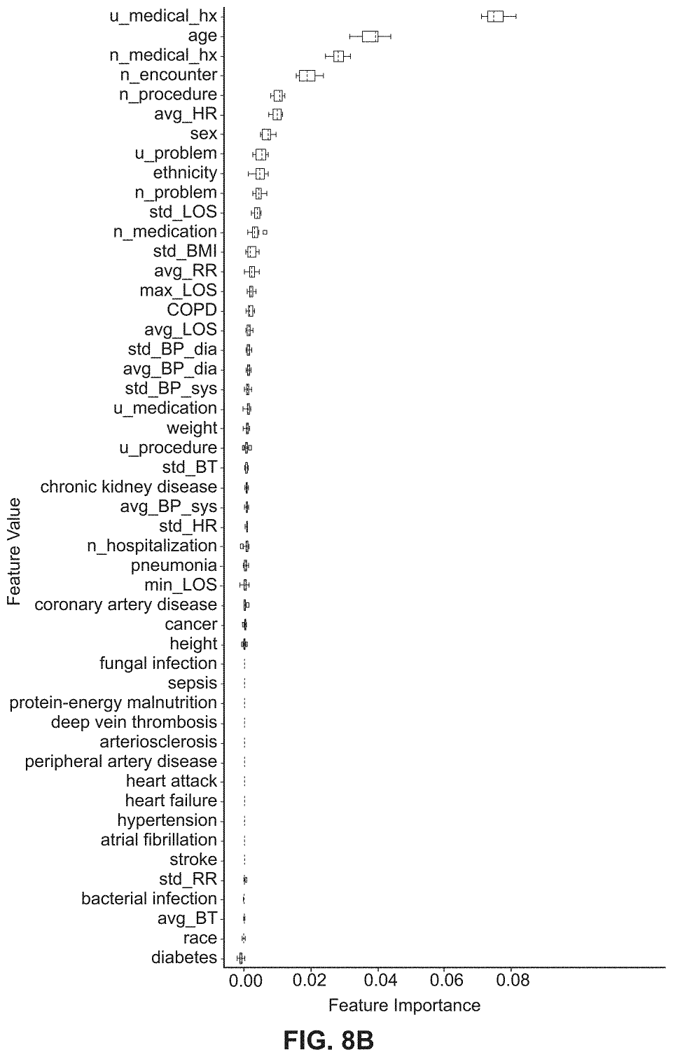

To ensure the stability and reliability of the model, SHAP and permutation testing methods were implemented on the GB model. These methods typically improve the interpretability of the black box model and generally give a reasonable explanation for the prediction of each outcome. The results for the SHAP algorithm are shown in FIG. 4A through FIG. 7B. In addition, L1-LR and permutation results for model 4 are presented in FIG. 8A and FIG. 8B. In models 1-3, where record-size features were not used, SHAP showed age as the dominant feature for predicting sepsis. Other important features included sex, ethnicity, respiratory rate, heart rate, standard deviation of BMI, history of sepsis, diabetes, and chronic kidney disease. In model 4, where record-size features were added, the most predictive features were the number of unique entries (u_history_hx), followed by age, the total count of history entries (n_history_hx), the total count of encounters (n_encounter), sex, and the total count of ordered procedures (n_procedure). The important features identified in the SHAP algorithm have high permutation importance and high absolute values of coefficients learned by L1-LR models. The sign of the coefficients showed the directionality of those features. Moreover, the average diastolic blood pressure (avg_BP_dia) and the total count of encounters (n_encounter) were assigned with a negative coefficient in all three models, which implied the effect of high values for these features in decreasing the risk of developing sepsis.

### Principal Findings

As can be seen, the results demonstrate that each of the trained machine-learning models are capable of predicting the two-year risk of sepsis in adults, and are interpretable. Model 4, with the inclusion of the record-size features in the input outperformed the others, with an AUROC of 0.8216 achieved by the GB algorithm in the training set. Due to the low prevalence of sepsis outcomes in the 20% test set, the precision was low in all models. However, the positive likelihood ratio of 2.8897 and negative likelihood ratio of 0.3192 achieved by model 4 showed that the model has the ability to identify subjects with higher risk of sepsis. The dominant features in this model, making up more than half of the feature importance, were record-size metrics of the numbers of unique and total history entries (u_history_hx and n_history_hx), and age. History features suggest an increased burden of underlying conditions, and aging is the most substantial risk factor for multimorbidity. Comorbidities are known to be significantly higher in subjects with sepsis compared to those without sepsis, but previous models have not included multimorbidity as a distinct feature. Another strong predictor in model 4 was the total number of ordered procedures (n_procedure). Procedures, particularly those that are invasive, increase the risk of treatment facility-acquired infections, and may also be indicative of status and multimorbidity. The total number of encounters (n_encounter), which was assigned a negative coefficient in L1-LR, was also a strong predictor in model 4. Although it requires further investigation, one possible reason could be that a greater number of visits is associated with better access to preventative measures.

Age, ethnicity, sex, average heart rate (avg_HR), and standard deviation of BMI (std_BMI) were the most important features in models 2 and 3. In addition to increasing the risk of multimorbidity, age is a known independent risk factor for sepsis incidence, severity, and outcomes. Whether ethnicity represents a sepsis risk factor is not yet established as results from epidemiological analyses are contrasting. Ethnicity may also be associated with socioeconomic status, a determinant found to be associated with infection treatment facility visit rates. A higher resting heart rate, which is common in infection, is also a risk factor for all-cause death and may suggest a poorer status. Subjects with higher average heart rates may have had infections during previous encounters. Obesity and malnourishment are known risk factors for sepsis, but the standard deviation of BMI (change over time) is a new potential risk factor and merits investigation. In models 3 and 4, physical attributes and vital signs (age, ethnicity, sex, BMI, and heart rate) appeared to be more stronger predictors than well-established conditions known to be sepsis risk factors, including heart failure, chronic kidney disease, and chronic obstructive pulmonary disease (COPD). Taken together, these outcomes suggest the possibility that sepsis risk is associated with not only age and conditions, but also vital signs and features related to record size.

In models 3 and 4 that incorporated historical features, the conditions with greater importance for long-term sepsis risk were history of sepsis, heart failure, chronic kidney disease, pneumonia, COPD, and diabetes. In contrast, the most impactful chronic diseases in the REGARDS 10-year prediction score were chronic lung disease, followed by diabetes and peripheral artery disease. The difference in risk factors between REGARDS and the prediction models may reflect a different subject sample and prediction window, but could also reflect differing definitions for conditions. For example, REGARDS used markers (e.g., estimated glomerular filtration rate, urinary albumin-to-creatinine ratio, and cystatin-C) for chronic kidney disease. Diagnostic codes were selected, which are less precise, but more likely to be consistently implementable on data. SNOMED CT was selected because it is a curated semantic ontology, which is structured as a directed acyclic graph and used in record data across many countries. These codes can be mapped to international classification of disease (ICD-10) codes, but different systems may benefit from retraining and retesting the model for their specific subjects.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed:

1. A computer-implemented method comprising:
identifying electronic data that is longitudinal and includes a set of electronic records pertaining to a given subject or to a given object, wherein each electronic record of the set of electronic records includes a timestamp and identifies an observation made by, process performed by, or diagnosis made by a verified entity across a predefined time period of at least six months;
generating a record-size metric that characterizes a size of the electronic data;
determining a physical attribute of the given subject or the given object, wherein the physical attribute corresponds to a size, a dimension, weight or age;
generating a physical-attribute metric based on the physical attribute;
generating an input data set that includes the record-size metric and the physical-attribute metric;
generating a failure probability across a given time period of at least one week and for the given subject or the given object by processing the input data set using a trained machine-learning model;
determining that an alert condition is satisfied based on the failure probability; and
in response to determining that the alert condition is satisfied, outputting an alert representing the failure probability.

2. The computer-implemented method of claim 1, wherein the record-size metric identifies a total quantity of electronic records in the set of electronic records.

3. The computer-implemented method of claim 1, wherein the record-size metric identifies a quantity of unique electronic records in the set of electronic records.

4. The computer-implemented method of claim 1, wherein the physical attribute identifies an age.

5. The computer-implemented method of claim 1, further comprising:
collecting one or more vital-sign measurements using a sensor that is attached to or worn by the given subject or the given object; and
generating a vital-sign metric based on the vital-sign measurements, wherein the input data set includes the vital-sign metric.

6. The computer-implemented method of claim 5, wherein the alert is output on a device that includes the sensor.

7. The computer-implemented method of claim 1, further comprising:
collecting one or more movement measurements using a sensor that is attached to or worn by the given subject or the given object; and
generating a movement metric based on the movement measurements, wherein the input data set includes the movement metric.

8. The computer-implemented method of claim 7, wherein the alert is output on a device that includes the sensor.

9. The computer-implemented method of claim 1, further comprising:
collecting one or more vital-sign measurements using a sensor that is attached to or worn by the given subject or the given object;
determining that an additional alert condition is satisfied based on the vital-sign measurements; and
in response to determining that the additional alert condition is satisfied, outputting another alert.

10. A system comprising:
one or more data processors; and
a non-transitory computer readable storage medium containing instructions which, when executed on the one or more data processors, cause the one or more data processors to perform a set of actions including:
identifying electronic data that is longitudinal and includes a set of electronic records pertaining to a given subject or to a given object, wherein each electronic record of the set of electronic records includes a timestamp and identifies an observation made by, process performed by, or diagnosis made by a verified entity across a predefined time period of at least six months;
generating a record-size metric that characterizes a size of the electronic data;
determining a physical attribute of the given subject or the given object, wherein the physical attribute corresponds to a size, a dimension, weight or age;
generating a physical-attribute metric based on the physical attribute;
generating an input data set that includes the record-size metric and the physical-attribute metric;
generating a failure probability across a given time period of at least one week and for the given subject or the given object by processing the input data set using a trained machine-learning model;
determining that an alert condition is satisfied based on the failure probability; and
in response to determining that the alert condition is satisfied, outputting an alert representing the failure probability.

11. The system of claim 10, wherein the record-size metric identifies a total quantity of electronic records in the set of electronic records.

12. The system of claim 10, wherein the record-size metric identifies a quantity of unique electronic records in the set of electronic records.

13. The system of claim 10, wherein the physical attribute identifies an age.

14. The system of claim 10, wherein the set of actions further includes:
collecting one or more vital-sign measurements using a sensor that is attached to or worn by the given subject or the given object; and
generating a vital-sign metric based on the vital-sign measurements, wherein the input data set includes the vital-sign metric.

15. The system of claim 14, wherein the alert is output on a device that includes the sensor.

16. The system of claim 10, wherein the set of actions further includes:
collecting one or more movement measurements using a sensor that is attached to or worn by the given subject or the given object; and
generating a movement metric based on the movement measurements, wherein the input data set includes the movement metric.

17. The system of claim 16, wherein the alert is output on a device that includes the sensor.

18. The system of claim 10, wherein the set of actions further includes:
collecting one or more vital-sign measurements using a sensor that is attached to or worn by the given subject or the given object;
determining that an additional alert condition is satisfied based on the vital-sign measurements; and
in response to determining that the additional alert condition is satisfied, outputting another alert.

19. A computer-program product tangibly embodied in a non-transitory machine-readable storage medium, including instructions configured to cause one or more data processors to perform a set of actions including:
identifying electronic data that is longitudinal and includes a set of electronic records pertaining to a given subject or to a given object, wherein each electronic record of the set of electronic records includes a timestamp and identifies an observation made by, process performed by, or diagnosis made by a verified entity across a predefined time period of at least six months;
generating a record-size metric that characterizes a size of the electronic data;
determining a physical attribute of the given subject or the given object, wherein the physical attribute corresponds to a size, a dimension, weight or age;
generating a physical-attribute metric based on the physical attribute;
generating an input data set that includes the record-size metric and the physical-attribute metric;
generating a failure probability across a given time period of at least one week and for the given subject or the given object by processing the input data set using a trained machine-learning model;
determining that an alert condition is satisfied based on the failure probability; and
in response to determining that the alert condition is satisfied, outputting an alert representing the failure probability.

20. The computer-program product of claim 19, wherein the record-size metric identifies a total quantity of electronic records in the set of electronic records.

21. The computer-program product of claim 19, wherein the record-size metric identifies a quantity of unique electronic records in the set of electronic records.

22. The computer-program product of claim 19, wherein the physical attribute identifies an age.

23. The computer-program product of claim 19, wherein the set of actions further includes:
collecting one or more vital-sign measurements using a sensor that is attached to or worn by the given subject or the given object; and
generating a vital-sign metric based on the vital-sign measurements, wherein the input data set includes the vital-sign metric.

24. The computer-program product of claim 23, wherein the alert is output on a device that includes the sensor.

25. The computer-program product of claim 19, wherein the set of actions further includes:
collecting one or more movement measurements using a sensor that is attached to or worn by the given subject or the given object; and
generating a movement metric based on the movement measurements, wherein the input data set includes the movement metric.

26. The computer-program product of claim 25, wherein the alert is output on a device that includes the sensor.

27. The computer-program product of claim 19, wherein the set of actions further includes:
collecting one or more vital-sign measurements using a sensor that is attached to or worn by the given subject or the given object;
determining that an additional alert condition is satisfied based on the vital-sign measurements; and
in response to determining that the additional alert condition is satisfied, outputting another alert.
